(19) United States
(12) Patent Application Publication
(10) Pub. No.: US 2020/0167661 A1
(43) Pub. Date: May 28, 2020

(54) PERFORMING DATA PROCESSING BASED ON DECISION TREE

(71) Applicant: Alibaba Group Holding Limited, George Town (KY)

(72) Inventors: Lichun Li, Hangzhou (CN); Jinsheng Zhang, Hangzhou (CN); Huazhong Wang, Hangzhou (CN)

(73) Assignee: Alibaba Group Holding Limited, George Town (KY)

(21) Appl. No.: 16/779,231

(22) Filed: Jan. 31, 2020

Related U.S. Application Data
(63) Continuation of application No. PCT/CN2020/071577, filed on Jan. 11, 2020.

(30) Foreign Application Priority Data
Jul. 1, 2019 (CN) 201910583525.5

(51) Int. Cl. G06N 5/00; G06N 20/20; H04L 9/06; G06N 5/04

(52) U.S. Cl. CPC G06N 5/003; G06N 5/04; H04L 9/0625; G06N 20/20

(57) ABSTRACT

Disclosed herein are methods, systems, and apparatus, including computer programs encoded on computer storage media, for data processing. One of the methods includes: determining a set of values in the set of splitting criteria based on the service data, wherein the set of values indicate whether the set of splitting criteria of the burst node are met; encrypting the set of values using a random number, to obtain cyphertext of the set of values; executing a secure data selection algorithm by using the ciphertext of the set of values as input; and executing a secure multi-party computation algorithm by using the random number as input to obtain a prediction result of a decision forest.

### CROSS-REFERENCE TO RELATED APPLICATIONS

This application is a continuation of PCT Application No. PCT/CN2020/071577, filed on Jan. 11, 2020, which claims priority to Chinese Patent Application No. 201910583525.5, filed on Jul. 1, 2019, and each application is hereby incorporated by reference in its entirety.

### TECHNICAL FIELD

Implementations of the present specification relate to the field of computer technologies, and in particular, to a data processing method and device, and an electronic device.

### BACKGROUND

During service implementation, generally, one party usually has a model that needs to be kept secret (hereafter referred to as a model owner), and the other party has service data that needs to be kept secret (hereafter referred to as a data owner). A technical problem that needs to be urgently resolved is to enable the model owner and/or the data owner to obtain a prediction result obtained by predicting service data based on a model while the model owner does not disclose the model and the data owner does not disclose the service data.

### SUMMARY

An object of implementations of the present specification is to provide a data processing method and device, and an electronic device, so that a model owner and/or a data owner obtain/obtains a prediction result obtained by predicting service data based on a model while the model owner does not disclose model data and/or service data of the model owner and the data owner does not disclose service data of the data owner.

To achieve the previous object, one or more implementations of the present specification provide the following technical solutions:

According to a first aspect of one or more implementations of the present specification, a data processing method is provided, applied to a model owner and including: selecting a burst node associated with service data of a data owner from a decision forest as a target burst node, where the decision forest includes at least one decision tree, the decision tree includes at least one burst node and at least two leaf nodes, the burst node corresponds to an actual splitting criterion and the leaf node corresponds to a leaf value; generating a fake splitting criterion for the target burst node; and sending a splitting criterion set corresponding to the target burst node to the data owner, where the splitting criterion set includes a fake splitting criterion and an actual splitting criterion.

According to a second aspect of one or more implementations of the present specification, a data processing device is provided, located at a model owner and including: a selection unit, configured to select a burst node associated with service data of a data owner from a decision forest as a target burst node, where the decision forest includes at least one decision tree, the decision tree includes at least one burst node and at least two leaf nodes, the burst node corresponds to an actual splitting criterion, and the leaf node corresponds to a leaf value; a generation unit, configured to generate a fake splitting criterion for the target burst node; and a sending unit, configured to send a splitting criterion set corresponding to the target burst node to the data owner, where the splitting criterion set includes a fake splitting criterion and an actual splitting criterion.

According to a third aspect of one or more implementations of the present specification, an electronic device is provided, including: a memory, configured to store computer instructions; and a processor, configured to execute the computer instructions to implement method steps according to the first aspect.

According to a fourth aspect of one or more implementations of the present specification, a data processing method is provided, applied to a data owner, where the data owner has service data and a splitting criterion set corresponding to a target burst node, the target burst node is a burst node associated with the service data in a decision forest, and the method includes: determining values of splitting criteria in a splitting criterion set based on service data, to obtain a value set; encrypting values in the value set by using a random number, to obtain a value ciphertext set; collaboratively executing a secure data selection algorithm with a model owner by using the value ciphertext set as an input; and collaboratively executing a secure multi-party computation algorithm with the model owner by using the random number as an input, so that the model owner and/or a data owner obtain/obtains a prediction result of a decision forest.

According to a fifth aspect of one or more implementations of the present specification, a data processing device is provided, located at a data owner, where the data owner has service data and a splitting criterion set corresponding to a target burst node, the target burst node is a burst node associated with the service data in a decision forest, and the device includes: a determining unit, configured to determine values of splitting criteria in a splitting criterion set based on service data, to obtain a value set; an encryption unit, configured to encrypt values in the value set by using a random number, to obtain a value ciphertext set; a first computation unit, configured to collaboratively execute a secure data selection algorithm with a model owner by using the value ciphertext set as an input; and a second computation unit, configured to collaboratively execute a secure multi-party computation algorithm with the model owner by using the random number as an input, so that the model owner and/or a data owner obtain/obtains a prediction result of a decision forest.

According to a sixth aspect of one or more implementations of the present specification, an electronic device is provided, including: a memory, configured to store computer instructions; and a processor, configured to execute the computer instructions to implement method steps according to the fourth aspect.

According to a seventh aspect of one or more implementations of the present specification, a data processing method is provided, applied to a model owner, where the model owner has a decision forest, the decision forest includes a target burst node, the target burst node is associated with service data of a data owner and corresponds to a splitting criterion set, the splitting criterion set includes an actual splitting criterion and a fake splitting criterion, and the method includes: using a rank of the actual splitting criterion in the splitting criterion set as a data selection value, and collaboratively executing a secure data selection algorithm with the model owner by using the data selection value as an input, to obtain a value ciphertext of the actual splitting criterion; and collaboratively executing a secure multi-party computation algorithm with the model owner by using the value ciphertext as an input, so that the model owner and/or a data owner obtain/obtains a prediction result of the decision forest.

According to an eighth aspect of one or more implementations of the present specification, a data processing device is provided, applied to a model owner, where the model owner has a decision forest, the decision forest includes a target burst node, the target burst node is associated with service data of a data owner and corresponds to a splitting criterion set, the splitting criterion set includes an actual splitting criterion and a fake splitting criterion, and the device includes: a first computation unit, configured to use a rank of the actual splitting criterion in the splitting criterion set as a data selection value, and collaboratively execute a secure data selection algorithm with the model owner by using the data selection value as an input, to obtain a value ciphertext of the actual splitting criterion; and a second computation unit, configured to collaboratively execute a secure multi-party computation algorithm with the model owner by using the value ciphertext as an input, so that the model owner and/or a data owner obtain/obtains a prediction result of the decision forest.

According to a ninth aspect of one or more implementations of the present specification, an electronic device is provided, including: a memory, configured to store computer instructions; and a processor, configured to execute the computer instructions to implement method steps according to the seventh aspect.

It can be learned from the previous technical solutions provided in the implementations of the present specification, in the data processing method according to the implementations, the fake splitting criterion is added for the burst node associated with the service data of the data owner, so that the model owner and/or the data owner obtain/obtains the prediction result of the decision forest while the model owner does not disclose its decision forest and service data and the data owner does not disclose its service data.

### BRIEF DESCRIPTION OF DRAWINGS

To describe the technical solutions in the implementations of the present specification or in the existing technology more clearly, the following outlines the accompanying drawings for illustrating such technical solutions. Clearly, the accompanying drawings outlined below are some implementations of the present specification and a person skilled in the art can derive other drawings from such accompanying drawings without creative efforts.

FIG. 1 is a schematic structural diagram illustrating a decision tree, according to an implementation of the present specification;

FIG. 2 is a flowchart illustrating a data processing method, according to an implementation of the present specification;

FIG. 3 is a flowchart illustrating a data processing method, according to an implementation of the present specification;

FIG. 4 is a schematic structural diagram illustrating a decision tree, according to an implementation of the present specification;

FIG. 5 is a flowchart illustrating a data processing method, according to an implementation of the present specification;

FIG. 6 is a flowchart illustrating a data processing method, according to an implementation of the present specification;

FIG. 7 is a functional schematic structural diagram illustrating a data processing device, according to an implementation of the present specification;

FIG. 8 is a functional schematic structural diagram illustrating a data processing device, according to an implementation of the present specification;

FIG. 9 is a functional schematic structural diagram illustrating a data processing device, according to an implementation of the present specification;

FIG. 10 is a functional schematic structural diagram illustrating an electronic device, according to an implementation of the present specification.

### DESCRIPTION OF IMPLEMENTATIONS

The technical solutions in the implementations of the present specification are described below clearly and comprehensively with reference to the accompanying drawings in the implementations of the present specification. Clearly, the described implementations are merely some of the implementations of the present specification, rather than all of the implementations. Based on the implementations of the present specification, a person skilled in the art can obtain other implementations without making creative efforts, which all fall within the scope of the present specification.

Secure Multi-Party Computation (MPC) is an algorithm for protecting data privacy security. With the secure multi-party computation technology, multiple participants can obtain a computation result through collaborative computation without disclosing their own data. The secure multi-party computation technology can be used to implement any type of mathematical operation, such as four arithmetic operation (addition, subtraction, multiplication, and division) and logic operations (AND, OR, and exclusive OR).

In actual applications, secure multi-party computation can be implemented in many manners. For example, parties, P₁, . . . , Pₙ can collaboratively compute the function ƒ (x₁, . . . , xₙ)=(y₁, . . . , yₙ)=y. n is greater than or equal to 2; x₁, . . . , xₙ are respectively data of participants, P₁, . . . , Pₙ; y is the computation result; y₁, . . . , yₙ are respectively shares of participants, P₁, . . . , Pₙ in the calculation result y; and y₁+y₂+ . . . +yₙ=y. For another example, by implementing secure multi-party computation, participants, P₁, . . . , Pₙ can collaboratively compute the function ƒ (x₁, . . . , xₙ)=y. One or more of the participants, P₁, . . . , Pₙ can obtain the computation result y after the computation is complete.

The secure data selection algorithm is a data selection algorithm for protecting privacy, and can be Oblivious Transfer (OT) or Private Information Retrieval (PIR) etc.

Oblivious transfer is a duplex protocol for protecting privacy. It allows communication parties to transfer data in a fuzzy selection manner. The sender can have a plurality of pieces of data. The receiver can receive one or more of the plurality of pieces of data through oblivious transfer. In this process, the sender does not know the data received by the receiver; and the receiver cannot obtain any data other than the received data.

Private information retrieval is a secure retrieval protocol for protecting privacy. The sender can have a plurality of pieces of data. The receiver can retrieve one or more of the plurality of pieces of data from the sender. The sender does not know the data retrieved by the receiver. The receiver does not know any data other than the retrieved data.

Decision tree: a supervised machine learning model. The decision tree can be a binary tree, etc. The decision tree can include a plurality of nodes. Each node can have corresponding location information. The location information is used to identify a location of the node in the decision tree. For example, the location information can be a number of the node. The plurality of nodes can form a plurality of prediction paths. A start node of a prediction path is a root node of the decision tree, and an end node of the prediction path is a leaf node of the decision tree.

The decision tree can include a regression decision tree and a classification decision tree. A prediction result of the regression decision tree can be a specific numerical value. A prediction result of the classification decision tree can be a specific category. It is worthwhile to note that, for ease of computation, a category is usually indicated by a vector. For example, vector [1 0 0] can indicate category A, vector [0 1 0] can indicate category B, and vector [0 0 1] can indicate category C. Certainly, the vectors are only examples. In actual applications, a category can be indicated by using another mathematic method.

Burst node: When a node in a decision tree can be downstream split, the node can be referred to as a burst node. The burst nodes can include a root node or other nodes (that is, nodes other than leaf nodes and the root node). The burst node corresponds to a splitting criterion and a data type, and the splitting criterion can be used to select a prediction path. A data type is used to indicate a type of data corresponding to the splitting criterion.

Leaf node: When a node in a decision tree cannot be downstream split, the node can be referred to as a leaf node. Each leaf node corresponds to a leaf value. Different leaf nodes in a decision tree can have a same or different corresponding leaf values. Each leaf node can indicate a prediction result. The leaf node can be a numerical value, a vector, etc. For example, a leaf value corresponding to a leaf node of the regression decision tree can be a numerical value, and a leaf value corresponding to a leaf node of the classification decision tree can be a vector.

To facilitate understanding of the previous terms, the following describes an example scenario.

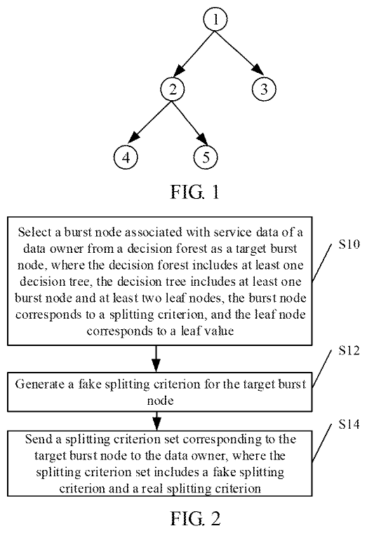

Refer to FIG. 1. In the example scenario, decision tree Tree1 can include five nodes: nodes 1, 2, 3, 4, and 5. Location information of nodes 1, 2, 3, 4, and 5 can be 1, 2, 3, 4, and 5, respectively. Node 1 is a root node; nodes 1, 2, and 3 are burst nodes; and nodes 3, 4, and 5 are leaf nodes. Nodes 1, 2, and 4 can form a prediction path; nodes 1, 2, and 5 can form another prediction path; and nodes 1 and 3 can form still another prediction path.

Splitting criteria corresponding to nodes 1, 2, and 3 are shown in Table 1.

TABLE 1

| Burst node | Splitting criterion | Data type |
|---|---|---|
| 1 | The age is over 20 years. | Age |
| 2 | The annual income is over | Income |
| | 50,000 yuan. | |

Leaf values corresponding to nodes 3, 4, and 5 are shown in Table 2.

TABLE 2

| Leaf node | Leaf value |
|---|---|
| 3 | 200 |
| 4 | 700 |
| 5 | 500 |

In Tree1, the splitting criteria “the age is over 20 years” and “the annual income is over 50,000 yuan” can be used to select a prediction path. When the splitting criterion is met, the prediction path on the left can be selected; when the splitting criterion is not met, the prediction path on the right can be selected. Specifically, for node 1, when the splitting criterion “the age is over 20 years” is met, the prediction path on the left can be selected, and then node 2 is jumped to; or when the splitting criterion “the age is over 20 years” is not met, the prediction path on the right can be selected, and then node 3 is jumped to. Specifically, for node 2, when the splitting criterion “the annual income is over 50,000 yuan” is met, the prediction path on the left can be selected, and then node 4 is jumped to; or when the splitting criterion “the annual income is over 50,000 yuan” is not met, the prediction path on the right can be selected, and then node 5 is jumped to.

One or more decision trees can form a decision forest. The decision forest can include a regression decision forest and a classification decision forest. The regression decision forest can include one or more regression decision trees. When the regression decision forest includes one regression decision tree, the prediction result of the regression decision tree can be used as the prediction result of the regression decision forest. When the regression decision forest includes a plurality of regression decision trees, summation can be performed on the prediction results of the plurality of regression decision trees, and the summation result can be used as the prediction result of the regression decision forest. The classification decision forest can include one or more classification decision trees. When the classification decision forest includes one classification decision tree, the prediction result of the classification decision tree can be used as the prediction result of the classification decision forest. When the classification decision forest includes a plurality of classification decision trees, statistical collection can be performed on the prediction results of the plurality of classification decision trees, and the result of the statistical collection can be used as the prediction result of the classification decision forest. It is worthwhile to note that, in some scenarios, the prediction result of the classification decision tree can be a vector, and the vector can be used to indicate a category. As such, summation can be performed on the prediction results of the plurality of classification decision trees, and the summation result can be used as the prediction result of the classification decision forest. For example, a classification decision tree can include the following decision trees: Tree2, Tree3, and Tree4. The prediction result of Tree2 can be vector [1 0 0], and [1 0 0] indicates category A. The prediction result of Tree3 can be vector [0 1 0], and [0 1 0] indicates category B. The prediction result of Tree4 can be vector [1 0 0], and [0 0 1] indicates category C. Then, summation can be performed on [1 0 0], [0 1 0], and [1 0 0], and the obtained vector [2 1 0] can be used as the prediction result of the classification decision forest. Vector [2 1 0] indicates that the quantity of times that the prediction result of the classification decision forest is category A is 2, the quantity of times that the prediction result of the classification decision forest is category B is 1, and the quantity of times that the prediction result of the classification decision forest is category C is 0.

The present specification provides an implementation of a data processing system.

The data processing system can include model owner and a data owner. Both the model owner and the data owner can be a server, a mobile phone, a tablet computer, a personal computer, etc. Alternatively, both the model owner and the data owner can be a system including a plurality of devices, for example, a server cluster including a plurality of servers. The model owner can have a decision forest that needs to be kept secret, and the data owner can have service data that needs to be kept secret. In actual applications, in some cases, the data owner has all service data. In some other cases, the model owner has a part of all the service data, and the data owner has another part of all the service data. For example, the model owner has transaction service data, and the data owner has loan service data. The model owner and the data owner can perform collaborative computation, so that the model owner and/or the data owner can obtain a prediction result obtained by predicting all the service data based on the decision forest.

Refer to FIG. 2. Based on the previous data processing system implementation, the present specification provides an implementation of a data processing method. In actual applications, the implementation is applied to a pre-processing phase. The execution entity of the implementation is a model owner. The implementation can include the following steps.

Step S10: Select a burst node associated with service data of a data owner from a decision forest as a target burst node, where the decision forest includes at least one decision tree, the decision tree includes at least one burst node and at least two leaf nodes, the burst node corresponds to an actual splitting criterion, and the leaf node corresponds to a leaf value.

In some implementations, each burst node in the decision tree corresponds to a splitting criterion. To distinguish between the splitting criterion from a fake splitting criterion described below, the splitting criterion here can be referred to as an actual splitting criterion.

In some implementations, that the burst node is associated with the service data of the data owner can be understood as: a data type corresponding to the burst node is the same as a data type of the service data of the data owner. The model owner can pre-obtain the data type of the service data of the data owner. As such, the model owner can select, from the decision forest, a burst node whose corresponding data type is the same as the data type of the service data of the data owner as a target burst node.

In some implementations, there are one or more target burst nodes. Specifically, in some implementations, the data owner has all service data, and the model owner does not have any service data. All burst nodes in the decision forest are associated with the service data of the data owner. As such, all the burst nodes in the decision forest are target burst nodes. In some other implementations, the data owner has a part of all the service data, and the model owner has another part of all the service data. Some burst nodes in the decision forest are associated with the service data of the data owner, and some other burst nodes are associated with the service data of the model owner. As such, some of the burst nodes in the decision forest are target burst nodes.

Step S12: Generate a fake splitting criterion for the target burst node.

In some implementations, the model owner can generate at least one fake splitting criterion for each target burst node. The fake splitting criterion can be generated randomly or based on a preset rule.

Step S14: Send a splitting criterion set corresponding to the target burst node to the data owner, where the splitting criterion set includes a fake splitting criterion and an actual splitting criterion.

In some implementations, after step S12 is performed, each target burst node can correspond to a fake splitting criterion and an actual splitting criterion, and can use a set including the fake splitting criterion and the actual splitting criterion as the splitting criterion set corresponding to the target burst node. The model owner can send a splitting criterion set corresponding to each target splitting node to the data owner. The data owner can receive the splitting criterion set corresponding to the target splitting node. Splitting criteria in the splitting criterion set can be arranged in a specific order, while a rank of an actual splitting criterion is random. Because the fake splitting criterion is added, the data owner does not know which splitting criterion in the splitting criterion set is an actual splitting criterion, thereby protecting the privacy of the decision forest.

In some implementations, the model owner can save a leaf value corresponding to a leaf node in the decision forest.

In some implementations, all burst nodes in the decision forest are associated with the service data of the data owner. That is, all the burst nodes in the decision forest are target burst nodes. In some other implementations, some burst nodes in the decision forest are associated with the service data of the data owner, and some other burst nodes are associated with the service data of the model owner. That is, the decision forest includes the target burst node and other burst nodes. That the burst node is associated with the model data of the data owner can be understood as: a data type corresponding to the burst node is the same as a data type of the service data of the model owner. As such, the model owner can save corresponding actual splitting criteria of other burst nodes.

In some implementations, the model owner can send location information of a burst node and location information of a leaf node in the decision forest to the data owner. The data owner can receive the location information of the burst node and the location of the leaf node in the decision forest; and reconstruct the topology of the decision tree in the decision forest based on the location information of the burst node and the leaf node in the decision forest. The topology of the decision tree can include a connection relationship between the burst node and the leaf node in the decision tree.

According to the data processing method provided in this implementation, the model owner can select a burst node associated with the service data of the data owner from a decision forest as the target burst node; generate a fake splitting criterion for the target burst node; and send a splitting criterion set corresponding to the target burst node to the data owner, where the splitting criterion set includes a fake splitting criterion and an actual splitting criterion. As such, the privacy of the decision forest is protected by adding a fake splitting criterion. In addition, all the service data can be easily predicted based on the decision forest.

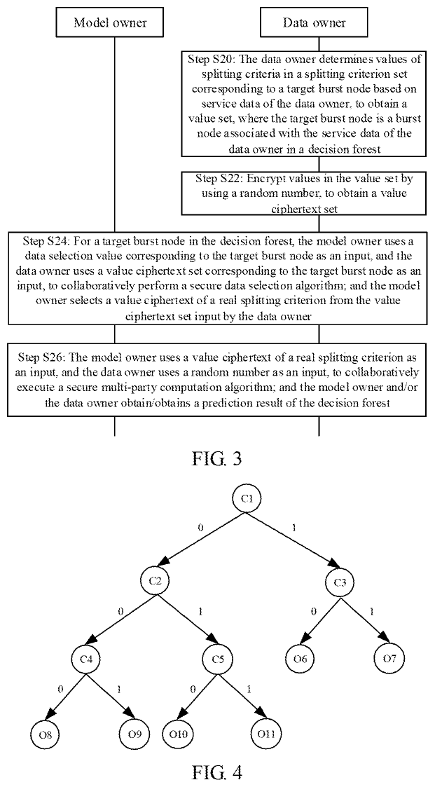

Refer to FIG. 3. Based on the previous data processing system implementation, the present specification provides another implementation of a data processing method. This implementation is applied to the prediction phase, and can include the following steps.

Step S20: A data owner determines values of splitting criteria in a splitting criterion set corresponding to a target burst node based on service data of the data owner, to obtain a value set, where the target burst node is a burst node associated with the service data of the data owner in a decision forest.

In some implementations, the data owner can obtain a splitting criterion set corresponding to the target burst node in the decision forest. The target burst node is a burst node associated with the service data of the data owner in the decision forest, and the splitting criterion set can include a fake splitting criterion and an actual splitting criterion. The data owner can determine values of splitting criteria in the splitting criterion set corresponding to the target burst node based on the service data, to obtain a value set. The value set can include at least two values, where the at least two values can include a value of the actual splitting criterion and the value of at least one fake splitting criterion.

The value of a splitting criterion can be used to indicate whether service data meets the splitting criterion. If the service data meets the splitting criterion, the value of the splitting criterion can be a first value; or if the service data does not meet the splitting criterion, the value of the splitting criterion can be a second value. For example, the first value can be 1, and the second value can be 0. In actual applications, for each target burst node in the decision forest, the data owner can determine values of all splitting criteria in the splitting criterion set corresponding to the target burst node based on the service data of the data owner, and can use the determined values as the values in the value set corresponding to the target burst node.

Step S22: Encrypt values in the value set by using a random number, to obtain a value ciphertext set;

In some implementations, the value ciphertext set can include at least two value ciphertexts, where the at least two value ciphertexts can include a value ciphertext of the actual splitting criterion and a value ciphertext of at least one fake splitting criterion.

In some implementations, the data owner can generate a random number for each target burst node. For each target burst node in the decision forest, the data owner can encrypt values in the value set corresponding to the target burst node by using the random number of the target burst node, and use the encryption results as the value ciphertexts in the value ciphertext set corresponding to the target burst node. This implementation does not limit the encryption manner. For example, encryption can be performed by performing an exclusive OR operation on a random number and a value of a burst node.

Step S24: For a target burst node in the decision forest, the model owner uses a data selection value corresponding to the target burst node as an input, and the data owner uses a value ciphertext set corresponding to the target burst node as an input, to collaboratively perform a secure data selection algorithm. The model owner selects a value ciphertext of an actual splitting criterion from the value ciphertext set input by the data owner.

In some implementations, as an input of the model owner during execution of the secure data selection algorithm, the data selection value can be used to select a value ciphertext from the value ciphertext set input by the data owner during execution of the secure data selection algorithm. The model owner can use a rank of an actual splitting criterion in the splitting criterion set corresponding to the target burst node as a data selection value corresponding to the target burst node. For example, a splitting criterion set includes four splitting criteria: Criterion1, Criterion2, Criterion3, and Criterion4. Criterion1, Criterion2, and Criterion4 are fake splitting criteria, and Criterion3 is an actual splitting criterion. The splitting criteria in the splitting criterion set are in the following order: Criterion1, Criterion2, Criterion3, and Criterion4. Then, the rank of the actual splitting criterion Criterion3 is 3.

In some implementations, for a target burst node in the decision forest, the model owner can use a data selection value corresponding to the target burst node as an input, and the data owner can use a value ciphertext set corresponding to the target burst node as an input, to collaboratively perform a secure data selection algorithm. The model owner can select a value ciphertext of an actual splitting criterion from the value ciphertext set. Based on features of the secure data selection algorithm, the data owner does not know which leaf value ciphertext is selected by the model owner as the target leaf value ciphertext, and the model owner does not know any value ciphertext other than the selected target value ciphertext. The secure data selection algorithm can include an oblivious transfer algorithm, a privacy information retrieval algorithm, etc.

Step S26: The model owner uses a value ciphertext of an actual splitting criterion as an input, and the data owner uses a random number as an input, to collaboratively execute a secure multi-party computation algorithm. The model owner and/or the data owner obtain/obtains a prediction result of the decision forest.

In some implementations, after step S24 is performed, the model owner obtains the value ciphertext of the actual splitting criterion corresponding to each target splitting node. For each decision tree in the decision forest, the model owner can use the value ciphertext of the actual splitting criterion corresponding to each target burst node in the decision tree and a leaf value corresponding to a leaf node as an input, and the data owner can use the random number corresponding to each target splitting node in the decision tree as an input, to collaboratively execute the secure multi-party computation algorithm. The model owner and/or the data owner can obtain the prediction result of the decision tree. The model owner and/or the data owner can determine the decision result of the decision forest based on the prediction result of each decision tree in the decision forest. For a specific determining manner, references can be made to the previous descriptions. Details are omitted here for simplicity.

In some implementations, all burst nodes in the decision forest are associated with the service data of the data owner. That is, all the burst nodes in the decision forest are target burst nodes. In some other implementations, some burst nodes in the decision forest are associated with the service data of the data owner, and some other burst nodes are associated with the service data of the model owner. That is, the decision forest includes the target burst node and other burst nodes. As such, the model owner can determine a value of the actual splitting criterion corresponding to the another burst node based on the service data of the model owner. For each decision tree in the decision forest, the model owner can use the value ciphertext of the actual splitting criterion corresponding to each target burst node in the decision tree and a leaf value corresponding to a leaf node as an input, and the data owner can use the random number corresponding to each target splitting node in the decision tree as an input, to collaboratively execute the secure multi-party computation algorithm. The model owner and/or the data owner can obtain the prediction result of the decision tree.

In some implementations, the manner in which the model owner and/or the data owner obtain/obtains the prediction result of the decision tree varies with a type of the secure multi-type computation algorithm. For example, both the model owner and the data owner can obtain a share of the prediction result of the decision tree by executing secure multi-type computation. For ease of differentiation, the share obtained by the model owner can be referred to as a first share, and the share obtained by the data owner can be referred to as a second share. The model owner can send the first share to the data owner. The data owner can receive the first share, and can add up the first share and the second share, to obtain the decision result of the decision tree. Alternatively, the data owner can send the second share to the model owner. The model owner can receive the second share, and can add up the first share and the second share, to obtain the decision result of the decision tree. Alternatively, the model owner can send the first share to the data owner, and the data owner can receive the first share; and the data owner can send the second share to the model owner, and the model owner can receive the second share. By adding up the first share and the second share, both the model owner and the data owner can obtain the prediction result of the decision result of the decision tree. For another example, by executing the secure multi-party computation algorithm, the model owner and/or the data owner can directly obtain the prediction result of the decision tree.

The following describes an example application scenario. It is worthwhile to note that the example application scenario is merely intended to better describe the implementations of the present specification and does not constitute any limitation on the implementations.

Refer to FIG. 4. In this example scenario, the decision tree Tree2 can include the following nodes: C1, C2, C3, C4, C5, O6, O7, O8, O9, O10, and O11. Nodes C1, C2, C3, C4, and C5 are burst nodes, and nodes O7, O8, O9, O10, and O11 are leaf nodes. In the decision tree Tree2, a branch on the left side of a burst node is a branch with value 0, which indicates that the branch does not meet the splitting criterion; and a branch on the right side of a burst node is a branch with value 1, which indicates that the branch meets the splitting criterion.

In this example scenarios, the model owner has the decision tree Tree2. The data owner has all service data. The burst nodes C1, C2, C3, C4, and C5 in the decision tree Tree2 are all associated with the service data of the data owner.

The prediction result of the decision tree Tree2 can be expressed by using the following formula.

$${v}_{Tree 2} = ( ( {v}_{o 8} \times ( 1 - {v}_{c 4} ) + {v}_{o 9} \times {v}_{c 4} ) \times ( 1 - {v}_{c 2} ) + ( {v}_{o 10} \times ( 1 - {v}_{c 5} ) + {v}_{o 11} \times {v}_{c 5} ) \times {v}_{c 2} ) \times ( 1 - {v}_{c 1} ) + ( {v}_{o 6} \times ( 1 - {v}_{c 3} ) + {v}_{o 7} \times {v}_{c 3} ) \times {v}_{c 1} = {v}_{o 8} \times ( 1 - {v}_{c 4} ) \times ( 1 - {v}_{c 2} ) \times ( 1 - {v}_{c 1} ) + {v}_{o 9} \times {v}_{c 4} \times ( 1 - {v}_{c 2} ) \times ( 1 - {v}_{c 1} ) + {v}_{o 10} \times ( 1 - {v}_{c 5} ) \times ( 1 - {v}_{c 2} ) \times ( 1 - {v}_{c 1} ) + {v}_{o 11} \times {v}_{c 5} \times ( 1 - {v}_{c 2} ) \times ( 1 - {v}_{c 1} ) + {v}_{o 6} \times ( 1 - {v}_{c 3} ) \times {v}_{c 1} + {v}_{o 7} \times {v}_{c 3} \times {v}_{c 1} \qquad ( 1 )$$

In formula (1): v_{Tree2} indicates the prediction result of the decision tree Tree2; and vₒ₆ indicates the leaf value of the leaf node O6. By analogy, vₒ₁₁ indicates the leaf value of the leaf node O11; and v_{c1} indicates the value ciphertext of the actual splitting criterion corresponding to the burst node C1. By analogy, v_{c5} indicates the value ciphertext of the actual splitting criterion corresponding to the burst node C5.

The model owner can use v_{c1}, . . . , v_{c5}, . . . vₒ₆, . . . , vₒ₁₁ as an input, and the data owner can use the random numbers of the burst nodes C1, C2, C3, C4, and C5 as an input, to collaboratively execute the secure multi-party selection algorithm. After executing the secure multi-party selection algorithm, the model owner can obtain a share v1_{Tree2} of v_{Tree2}, and the data owner can obtain another share v2_{Tree2} of v_{Tree2}. The model owner can send v1_{Tree2} to the data owner. The data owner can receive v1_{Tree2}, and can add up v1_{Tree2} and v2_{Tree2}, to obtain v_{Tree2}.

According to the data processing method provided in this implementation, the fake splitting criterion is added for the burst node associated with the service data of the data owner, so that the model owner and/or the data owner obtain/obtains the prediction result of the decision forest while the model owner does not disclose its decision forest and service data of the model owner and the data owner does not disclose its service data.

Refer to FIG. 5. Based on the same inventive concept, the present specification provides another implementation of a data processing method. The execution entity of the implementation is a data owner. The implementation can include the following steps.

Step S30: Determine values of splitting criteria in the splitting criterion set based on the service data, to obtain a value set.

Step S32: Encrypt values in the value set by using a random number, to obtain a value ciphertext set.

Step S34: Collaboratively execute a secure data selection algorithm with a model owner by using the value ciphertext set as an input.

Step S36: Collaboratively execute a secure multi-party computation algorithm with the model owner by using the random number as an input, so that the model owner and/or a data owner obtain/obtains a prediction result of a decision forest.

For a specific process of steps S30, S32, S34, and S36, references can be made to the implementation corresponding to FIG. 2. Details are omitted here for simplicity.

According to the data processing method provided in this implementation, the fake splitting criterion is added for the burst node associated with the service data of the data owner, so that the model owner and/or the data owner obtain/obtains the prediction result of the decision forest while the model owner does not disclose its decision forest and service data and the data owner does not disclose its service data.

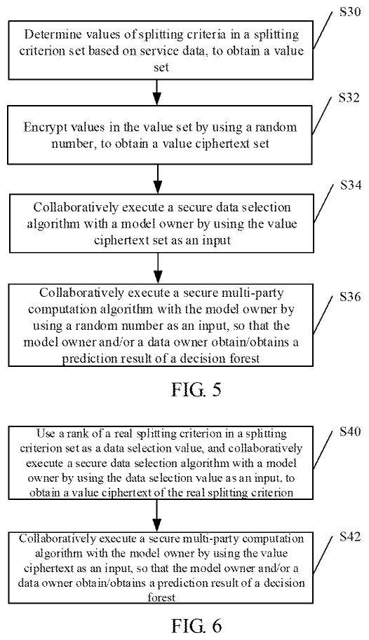

Refer to FIG. 6. Based on the same inventive concept, the present specification provides another implementation of a data processing method. The execution entity of the implementation is a model owner. The implementation can include the following steps.

Step S40: Use a rank of the actual splitting criterion in the splitting criterion set as a data selection value, and collaboratively executing a secure data selection algorithm with the model owner by using the data selection value as an input, to obtain a value ciphertext of the actual splitting criterion.

Step S42: Collaboratively execute a secure multi-party computation algorithm with the model owner by using the value ciphertext as an input, so that the model owner and/or a data owner obtain/obtains a prediction result of the decision forest.

For a specific process of steps S40 and S42, references can be made to the implementation corresponding to FIG. 2. Details are omitted here for simplicity.

According to the data processing method provided in this implementation, the fake splitting criterion is added for the burst node associated with the service data of the data owner, so that the model owner and/or the data owner obtain/obtains the prediction result of the decision forest while the model owner does not disclose its decision forest and service data and the data owner does not disclose its service data.

Refer to FIG. 7. The present specification further provides an implementation of a data processing device. The data processing device can be located at a model owner. The device can include the following units: a selection unit 50, configured to select a burst node associated with service data of a data owner from a decision forest as a target burst node, where the decision forest includes at least one decision tree, the decision tree includes at least one burst node and at least two leaf nodes, the burst node corresponds to an actual splitting criterion, and the leaf node corresponds to a leaf value; a generation unit 52, configured to generate a fake splitting criterion for the target burst node; and a sending unit 54, configured to send a splitting criterion set corresponding to the target burst node to the data owner, where the splitting criterion set includes a fake splitting criterion and an actual splitting criterion.

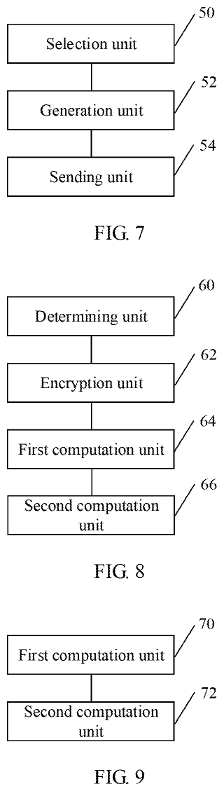

Refer to FIG. 8. The present specification further provides an implementation of a data processing device. The data processing device can be located at a data owner, where the data owner has service data and a splitting criterion set corresponding to a target burst node, and the target burst node is a burst node associated with the service data in a decision forest. The device can include the following units: a determining unit 60, configured to determine values of splitting criteria in the splitting criterion set based on the service data, to obtain a value set; an encryption unit 62, configured to encrypt values in the value set by using a random number, to obtain a value ciphertext set; a first computation unit 64, configured to collaboratively execute a secure data selection algorithm with a model owner by using the value ciphertext set as an input; and a second computation unit 66, configured to collaboratively execute a secure multi-party computation algorithm with the model owner by using the random number as an input, so that the model owner and/or a data owner obtain/obtains a prediction result of a decision forest.

Refer to FIG. 9. The present specification further provides an implementation of a data processing device. The data processing device can be located at a model owner, where the model owner has a decision forest, the decision forest includes a target burst node, the target burst node is associated with service data of a data owner and corresponds to a splitting criterion set, and the splitting criterion set includes an actual splitting criterion and a fake splitting criterion. The device can include the following units: a first computation unit 70, configured to use a rank of the actual splitting criterion in the splitting criterion set as a data selection value, and collaboratively execute a secure data selection algorithm with the model owner by using the data selection value as an input, to obtain a value ciphertext of the actual splitting criterion; and a second computation unit 72, configured to collaboratively execute a secure multi-party computation algorithm with the model owner by using the value ciphertext as an input, so that the model owner and/or a data owner obtain/obtains a prediction result of the decision forest.

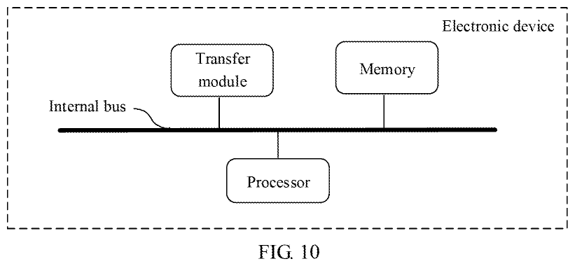

The following describes one implementation of an electronic device provided in the present specification. FIG. 10 is a schematic diagram illustrating a hardware structure of an electronic device provided in an implementation of the present specification. As shown in FIG. 10, the electronic device can include one or more processors (only one processor is shown), memories, and transfer modules. Certainly, a person of ordinary skill in the art should understand that the hardware structure shown in FIG. 10 is merely an example and does not constitute any limitation on the hardware structure of the electronic device. In practice, the electronic device can include more or fewer components than those shown in FIG. 10; or have a configuration different than that shown in FIG. 10.

The memory can include a high-speed random access memory; or can include a nonvolatile memory, such as one or more magnetic storage devices, a flash memory, or another nonvolatile solid-state memory. Certainly, the memory can alternatively include a remote network memory. The remote network memory can be connected to the electronic device through the Internet, an enterprise intranet, a local area network, a mobile communications network, etc. The memory can be configured to store program instructions or modules of application software, such as program instructions or modules of the implementation corresponding to FIG. 2 in the present specification, program instructions or modules of the implementation corresponding to FIG. 5, or program instructions or modules of the implementation corresponding to FIG. 6.

The processor can be implemented by using an appropriate method. For example, the processor can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. The processor can read and execute program instructions or modules in the memory.

The transfer module can be configured to transfer data through a network, for example, through the Internet, an enterprise intranet, a local area network, or a mobile communications network.

It is worthwhile to note that the implementations of the present specification are described in a progressive way. For same or similar parts of the implementations, mutual references can be made to the implementations. Each implementation focuses on a difference from the other implementations. Particularly, a device implementation and an electronic device implementation are basically similar to a data processing method implementation, and therefore are described briefly. For related parts, references can be made to related descriptions in the data processing method implementation.

In addition, it should be understood that, after reading the present specification, a person skilled in the art can freely combine some or all of the implementations in the present specification without creative efforts, and such combinations shall fall within the protection scope of the present specification.

In the 1990s, whether technology improvement is hardware improvement (for example, improvement of a circuit structure, such as a diode, a transistor, or a switch) or software improvement (improvement of a method procedure) can be obviously distinguished. However, as technologies develop, the current improvement for many method procedures can be considered as a direct improvement of a hardware circuit structure. A designer usually programs an improved method procedure to a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, the programming is mostly implemented by modifying “logic compiler” software instead of manually making an integrated circuit chip. This is similar to a software compiler used for program development and compiling. However, original code before compiling is also written in a specific programming language, which is referred to as a hardware description language (HDL). There are many HDLs, such as an Advanced Boolean Expression Language (ABEL), an Altera Hardware Description Language (AHDL), Confluence, a Cornell University Programming Language (CUPL), HDCal, a Java Hardware Description Language (JHDL), Lava, Lola, MyHDL, PALASM, and a Ruby Hardware Description Language (RHDL). Currently, a Very-High-Speed Integrated Circuit Hardware Description Language (VHDL) and Verilog2 are most commonly used. A person skilled in the art should also understand that a hardware circuit that implements a logical method procedure can be readily obtained once the method procedure is logically programmed by using the several described hardware description languages and is programmed into an integrated circuit.

The system, device, module, or unit illustrated in the previous implementations can be implemented by using a computer chip or an entity, or can be implemented by using a product having a certain function. A typical implementation device is a computer. A specific form of the computer can be a personal computer, a laptop computer, a cellular phone, a camera phone, an intelligent phone, a personal digital assistant, a media player, a navigation device, an email transceiver device, a game console, a tablet computer, a wearable device, or any combination thereof.

It can be learned from descriptions of the implementations that a person skilled in the art can clearly understand that the present specification can be implemented by using software in addition to a necessary universal hardware platform. Based on such an understanding, the technical solutions in the present specification essentially or the part contributing to the existing technology can be implemented in a form of a software product. The software product can be stored in a storage medium, such as a ROM/RAM, a magnetic disk, or an optical disc, and includes several instructions for instructing a computer device (such as a personal computer, a server, or a network device) to perform the methods described in the implementations or in some parts of the implementations of the present specification.

The present specification can be used in many general-purpose or dedicated computer system environments or configurations, for example, a personal computer, a server computer, a handheld device, a portable device, a tablet device, a mobile communications terminal, a multiprocessor system, a microprocessor system, a programmable electronic device, a network PC, a small computer, a mainframe computer, and a distributed computing environment including any of the above systems or devices.

The present specification can be described in the general context of computer executable instructions executed by a computer, for example, a program module. Generally, the program module includes a routine, a program, an object, a component, a data structure, etc. executing a specific task or implementing a specific abstract data type. The present specification can also be practiced in distributed computing environments. In the distributed computing environments, tasks are performed by remote processing devices connected through a communications network. In a distributed computing environment, the program module can be located in both local and remote computer storage media including storage devices.

Although the present specification is described by using the implementations, a person of ordinary skill in the art knows that many modifications and variations of the present specification can be made without departing from the spirit of the present specification. It is expected that the claims include these modifications and variations without departing from the spirit of the present specification.

What is claimed is:

1. A data processing method comprising:
determining, by a first computing device that possesses service data and a set of splitting criteria corresponding to a burst node of a decision tree, a set of values in the set of splitting criteria based on the service data, wherein the set of values indicate whether the set of splitting criteria of the burst node are met;
encrypting, by the first computing device, the set of values using a random number, to obtain cyphertext of the set of values;
executing, by the first computing device with a second computing device that possesses a decision tree model of the decision tree, a secure data selection algorithm by using the ciphertext of the set of values as input; and
executing, by the first computing device with the second computing device, a secure multi-party computation algorithm by using the random number as input to obtain a prediction result of a decision forest.

2. The method according to claim 1, wherein the service data possessed by the first computing device is at least a portion of all service data, and a remainder of all the service data other than the service data processed by the first computing device is possessed by the first computing device;
the set of splitting criteria comprises a fake splitting criterion and an actual splitting criterion; and
the secure data selection algorithm is selected from an oblivious transfer algorithm and a privacy information retrieval algorithm.

3. The method according to claim 1, wherein the set of values further comprises values in a second set of splitting criteria of a second burst node of the decision tree, wherein the values in the second set of splitting criteria indicate whether the set of splitting criteria of the second burst node are met, and wherein the cyphertext of the set of values further comprises the values in the second set of splitting criteria encrypted by a second random number generated for the second burst node.

4. The method according to claim 1, wherein the encrypting the set of values to obtain the cyphertext of the set of values is performed by executing an exclusive OR (XOR) operation between the random number and each value in the set of values.

5. A computer-implemented system, comprising one or more computers, and one or more computer memory devices interoperably coupled with the one or more computers and having tangible, non-transitory, machine-readable media storing one or more instructions that, when executed by the one or more computers, perform operations comprising:
determining, by a first computing device that possesses service data and a set of splitting criteria corresponding to a burst node of a decision tree, a set of values in the set of splitting criteria based on the service data, wherein the set of values indicate whether the set of splitting criteria of the burst node are met;
encrypting, by the first computing device, the set of values using a random number, to obtain cyphertext of the set of values;
executing, by the first computing device with a second computing device that possesses a decision tree model of the decision tree, a secure data selection algorithm by using the ciphertext of the set of values as input; and
executing, by the first computing device with the second computing device, a secure multi-party computation algorithm by using the random number as input to obtain a prediction result of a decision forest.

6. The computer-implemented system according to claim 5, wherein the service data possessed by the first computing device is at least a portion of all service data, and a remainder of all the service data other than the service data processed by the first computing device is possessed by the first computing device;
the set of splitting criteria comprises a fake splitting criterion and an actual splitting criterion; and
the secure data selection algorithm is selected from an oblivious transfer algorithm and a privacy information retrieval algorithm.

7. The computer-implemented system according to claim 5, wherein the set of values further comprises values in a second set of splitting criteria of a second burst node of the decision tree, wherein the values in the second set of splitting criteria indicate whether the set of splitting criteria of the second burst node are met, and wherein the cyphertext of the set of values further comprises the values in the second set of splitting criteria encrypted by a second random number generated for the second burst node.

8. The computer-implemented system according to claim 5, wherein the encrypting the set of values to obtain the cyphertext of the set of values is performed by executing an exclusive OR (XOR) operation between the random number and each value in the set of values.

9. A non-transitory, computer-readable medium storing one or more instructions executable by a computer system to perform operations comprising:
determining, by a first computing device that possesses service data and a set of splitting criteria corresponding to a burst node of a decision tree, a set of values in the set of splitting criteria based on the service data, wherein the set of values indicate whether the set of splitting criteria of the burst node are met;
encrypting, by the first computing device, the set of values using a random number, to obtain cyphertext of the set of values;
executing, by the first computing device with a second computing device that possesses a decision tree model of the decision tree, a secure data selection algorithm by using the ciphertext of the set of values as input; and
executing, by the first computing device with the second computing device, a secure multi-party computation algorithm by using the random number as input to obtain a prediction result of a decision forest.

10. The non-transitory, computer-readable medium of claim 9, wherein the service data possessed by the first computing device is at least a portion of all service data, and a remainder of all the service data other than the service data processed by the first computing device is possessed by the first computing device;
the set of splitting criteria comprises a fake splitting criterion and an actual splitting criterion; and
the secure data selection algorithm is selected from an oblivious transfer algorithm and a privacy information retrieval algorithm.

11. The non-transitory, computer-readable medium of claim 9, wherein the set of values further comprises values in a second set of splitting criteria of a second burst node of the decision tree, wherein the values in the second set of splitting criteria indicate whether the set of splitting criteria of the second burst node are met, and wherein the cyphertext of the set of values further comprises the values in the second set of splitting criteria encrypted by a second random number generated for the second burst node.

12. The non-transitory, computer-readable medium of claim 9, wherein the encrypting the set of values to obtain the cyphertext of the set of values is performed by executing an exclusive OR (XOR) operation between the random number and each value in the set of values.
